(19) United States
(12) Patent Application Publication
(10) Pub. No.: US 2014/0050554 A1
(43) Pub. Date: Feb. 20, 2014

(54) Wheel Handler

(71) Applicant: Frank Soto, Unanderra (AU)

(72) Inventor: Frank Soto, Unanderra (AU)

(21) Appl. No.: 13/969,500

(22) Filed: Aug. 16, 2013

(30) Foreign Application Priority Data
Aug. 16, 2012 (AU) 2012903534

(51) Int. Cl. B60B 30/02; B60B 29/00

(52) U.S. Cl. CPC B60B 30/02; B60B 29/00
USPC 414/426; 29/281.1; 414/800

(57) ABSTRACT

A wheel handler for handling a wheel in a confined space, the wheel handler comprising: a connector for connecting the wheel handler to a drive vehicle; and a handling device that in use is adapted to support the wheel, wherein at least a portion of the handling device is moveable in a lateral direction relative to the connector such that a wheel supported by the handling device is moved in a lateral direction relative to the connector.

### TECHNICAL FIELD

The present invention relates generally to a wheel handler for handling a wheel in a confined space.

### BACKGROUND ART

Removal of wheels or tyres from vehicles utilised within confined spaces can prove difficult. This is particularly the case in mines or other confined spaces in which there is a statutory requirement that the wheel or tyre be taken from the vehicle and transported to a safe place or to the surface for repair. This process means that fixing a damaged or flat tyre on a vehicle can be time consuming and greatly reduce efficiency. Tyre handlers are utilised to assist in removal and transport of the wheel or tyre from the vehicle to a maintenance area or the surface.

Previously known tyre handlers are cumbersome, and frequently require at least two users to be effective. The tyre handlers are generally guided and driven by a drive vehicle which requires direction by a second person in use. As a result, these tyre handlers are not safe because visibility of the second person is limited, especially in use in confined spaces. Use of the tyre handlers can be further restricted or complicated as maneuverability of the drive vehicle supporting the tyre handler is limited in a confined space meaning precise positioning of the wheel or tyre is difficult. This can result in greater manual movement of the tyre which is not ideal.

The above references to the background art do not constitute an admission that the art forms a part of the common general knowledge of a person of ordinary skill in the art. The above references are also not intended to limit the application of the process and product as disclosed herein.

### SUMMARY

According to an aspect of the invention, disclosed is a wheel handler for handling a wheel in a confined space, the wheel handler comprising: a connector for connecting the wheel handler to a drive vehicle; and a handling device that in use is adapted to support the wheel, wherein at least a portion of the handling device is moveable in a lateral direction relative to the connector such that a wheel supported by the handling device is moved in a lateral direction relative to the connector.

The foregoing summary is illustrative only and is not intended to be in any way limiting. In addition to the illustrative aspects, embodiments, and features described above, further aspects, embodiments and features will become apparent by reference to the drawings and the following detailed description.

### BRIEF DESCRIPTION OF THE DRAWINGS

Embodiments of the present invention will now be described by way of example only, with reference to the accompanying drawing in which:

FIG. 1 is a perspective view of an embodiment of a wheel handler according to the present invention;

FIG. 2 is a top view of the wheel handler as shown in FIG. 1

FIG. 3 is a side view of the wheel handler as shown in FIG. 1; and

FIG. 4 is a front schematic view of the wheel handler as shown in FIG. 1 accommodating different wheel sizes.

### DETAILED DESCRIPTION

The illustrative embodiments described in the detailed description, depicted in the drawings and defined in the claims, are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

This disclosure is directed generally to wheel handlers that are used for handling, removing and/or transporting wheels especially within a confined area. While the disclosure is described generally in the context of mining applications, it is not limited to such use, and may be used in other vehicle applications in confined spaces such as, for example, steel or heavy industry sectors.

Disclosed are embodiments of a wheel handler for handling a wheel in a confined space, the wheel handler comprising: a connector for connecting the wheel handler to a drive vehicle; and a handling device that in use is adapted to support the wheel, wherein at least a portion of the handling device is moveable in a lateral direction relative to the connector such that a wheel supported by the handling device is moved in a lateral direction relative to the connector.

In some forms, at least a portion of the handling device in use is moveable in a longitudinal direction relative to the connector such a wheel supported by the handling device is moveable between a proximal position and a distal position in relation to the drive vehicle.

In some forms, at least a portion of the handling device in use is moveable in a vertical plane relative to the connector such that a wheel supported by the handling device is moved in a vertical direction relative to the connector.

In some forms, the handling device comprises a contractable structure having a plurality of wheel supports configured such that a wheel supported by the wheel supports is moveable to the proximal position upon contraction.

In some forms, the contractable structure further comprises a clamp adapted to contact a surface of the wheel and secure the wheel with respect to the wheel supports.

In some forms, the clamp comprises an extendible body and a securing projection, and the extendible body extends in use in a radial direction of the wheel to support the wheel.

In some forms, the plurality of wheel supports and the securing projection are configured to be spaced apart about the circumference of the wheel.

In some forms, the handling device is in sliding engagement with the connector such that the handling device is moveable laterally in relation to the connector.

In some forms, the sliding engagement is in a direction that is substantially transverse the direction of movement of the plurality of wheel supports.

In some forms, the wheel handler further comprises a motorized rotation device adapted to rotate the wheel about a central axis to facilitate removal of the wheel from the vehicle.

In some forms, the handling device defines a space allowing a user to stand between the connector and the plurality of wheel supports.

Referring to the Figures, in some embodiments illustrated and disclosed is a wheel handler 10 for handling a wheel 12 in a confined space. Wheel handlers 10 are beneficial where space for handling the wheel 12 is limited and/or where the wheel 12 is heavy, making it difficult for one person to handle the wheel 12.

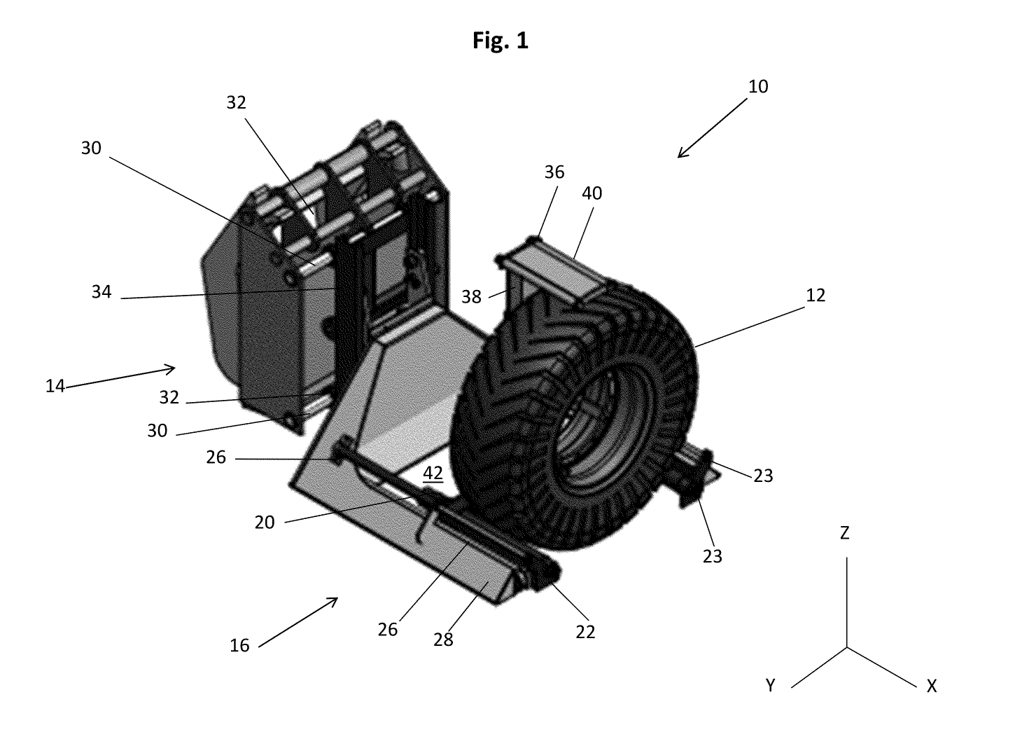

As shown in FIG. 1, the wheel handler 10 generally comprises a connector 14 for connecting the wheel handler 10 to a drive such as a drive vehicle (not shown) and a handling device 16 for handling the wheel 12. The connector 14 connects the wheel handler 10 to a drive vehicle via a coupling element 18. The coupling element is adapted to allow the wheel handler 10 to be removably engaged with a drive vehicle for maneuvering the wheel handler 10 within the confined space. For example, types of drive vehicles that the wheel handler 10 may connect to via the connector 14 are a load hauling device, a fork lift, a front end loader, a shuttle car or similar. In some forms, the coupling element 18 is in the form of a quick release mechanism.

In use, the drive vehicle positions the wheel handler 10, and in particular, positions the handling device 16 of the wheel handler 10 in a suitable position proximal to the wheel 12 for handling (i.e., removal or replacement of the wheel from a second vehicle).

The handling device 16 extends from the connector 14 to facilitate handling of the wheel 12 in that a portion of the handling device is moveable in a range of directions relative to the connector 14. In the illustrated embodiment, the handling device 16 moves in three directions relative the connector. For consistency these directions are referred to as X, Y, and Z.

Movement of a portion of the handling device 16 in the X and the Y directions denotes movement that is substantially horizontal to the ground and is understood to be movement in a lateral plane.

The X direction may also be defined as movement of the handling device 16 in a longitudinal direction relative to the connector 14 such that the wheel 12 is moveable between a position proximal the connector 14 and a position distal the connector 14. Movement in the X direction allows for movement of the wheel 12 in the same direction as movement of the drive vehicle. This also allows the wheel 12 to move proximal the drive vehicle and distal the drive vehicle. FIG. 1 shows the wheel 12 in the distal position.

Movement in the Y direction allows for side-to-side movement of the wheel handler with respect to the connector. The Y direction may also be referred to as movement in a lateral direction relative to the connector 14. It will be seen that this combination of movements in the X and Y directions allows for movement in the lateral plane with respect to the drive vehicle.

Movement in the Z direction is substantially vertical to the ground and is understood to be in the vertical plane. Movement in the Z direction allows for the wheel to be elevated with respect to the drive vehicle.

Movement in the X direction is effected by movement of a portion of the handling device 16. The handling device 16 generally comprises a contractable structure 20, wheel supports 22, arms 28, and a clamp 36. In the illustrated form, the contractable structure 20 is in the form of a telescoping inner member 24 and an outer tube 26. The inner member 24 of the contractable structure 20 has a slightly smaller diameter than the outer tube 26. This enables the inner member 24 to retract inside the outer tube 26 upon contraction, where the wheel 12 is in the proximal position.

In non-illustrated alternative embodiments, the inner tube 24 and outer tube 26 may be reversed, or any form of contractable structure may be used, such as a resilient member, a pneumatic or hydraulic arrangement, a foldable member, adjacent members in sliding arrangement or alternative configurations.

Each wheel support 22 comprises a plurality of contact members 23. In the illustrated form one wheel support member 23, comprises the inner member 24 of the contractable structure 20. The contact members 23 comprise two contact members 23 which are spaced apart about the circumference of the wheel 12 to contact the wheel 12 at two locations. In the illustrated form, two wheel supports 22 are positioned at about 160° and 200° degrees about the circumference of the wheel.

Further, the contractable structure 20 and the wheel supports 22 are supported by two arms 28 extending longitudinally from the handling device 16.

A portion of the handling device 16 also moves in the Y direction relative to the connector 14 in the lateral plane. Lateral movement in the Y direction is effected by the handling device 16 being in sliding engagement with the connector 14. In the illustrated form, the connector 14 comprises two elongate slide members 30 to which the handling device 16 is slideably connected.

The handling device 16 is engaged with the slide members 30 by complementary receiving members 32. Each elongate member 30 of the connector 14 passes through the complementary receiving member 32 of the handling device 16 to enable the handling device 16 to be in sliding engagement with the connector 14.

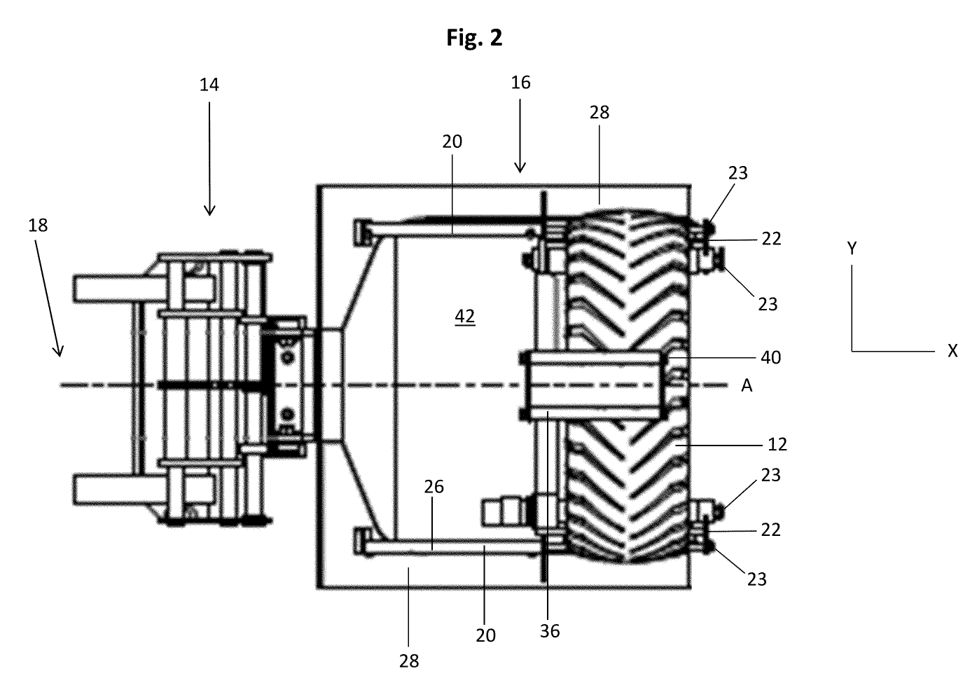

Referring to FIG. 2, the wheel handler 10 is shown in a top view where the handling device is in the distal position supporting the wheel 12. A portion of the handling device 16 is positioned in the Y direction with respect to the connector 14, which is illustrated by axis A that marks the centre of the connector 14 in the Y direction. The handling device 16 slides from side to side across a lateral side of the connector 14. This side to side movement is independent of the movement in the X direction (and in the Z direction). As a result, movement in the Y direction may be effected at the distal position, at the proximal position or at any position in between.

Further, the movement in the Y direction is substantially transverse the movement in the X direction. In the illustrated embodiment, the movement in the Y direction is perpendicular or at 90 degrees to the movement in the X direction.

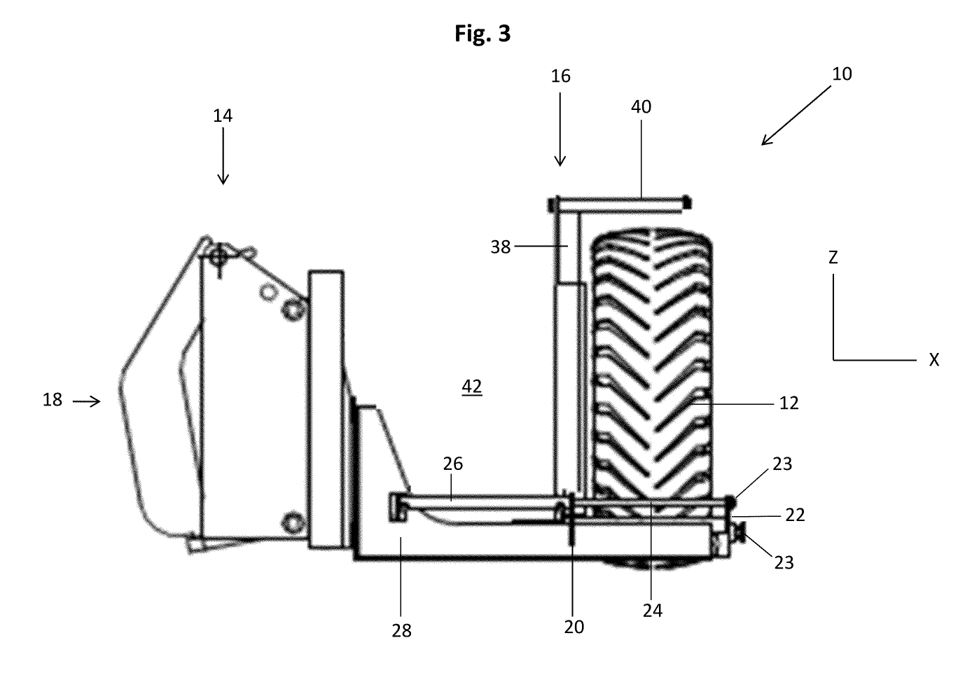

Referring to FIG. 3, the wheel handler 10 is shown in a side view and best illustrates movement of the handling device 16 in the vertical plane relative the connector 14. The handling device 16 connects the handling device 16 to the connector 14 via the complementary receiving elements 32, discussed above, and via brackets 34. The brackets 34 enable the handling device 16 to be in sliding engagement with the connector 14 in the vertical or Z direction. Movement in the Z direction is independent of movement in the X and Y directions. In other words, the handling device 16 may be in any position and be capable of movement in the vertical direction (i.e., the vertical plane).

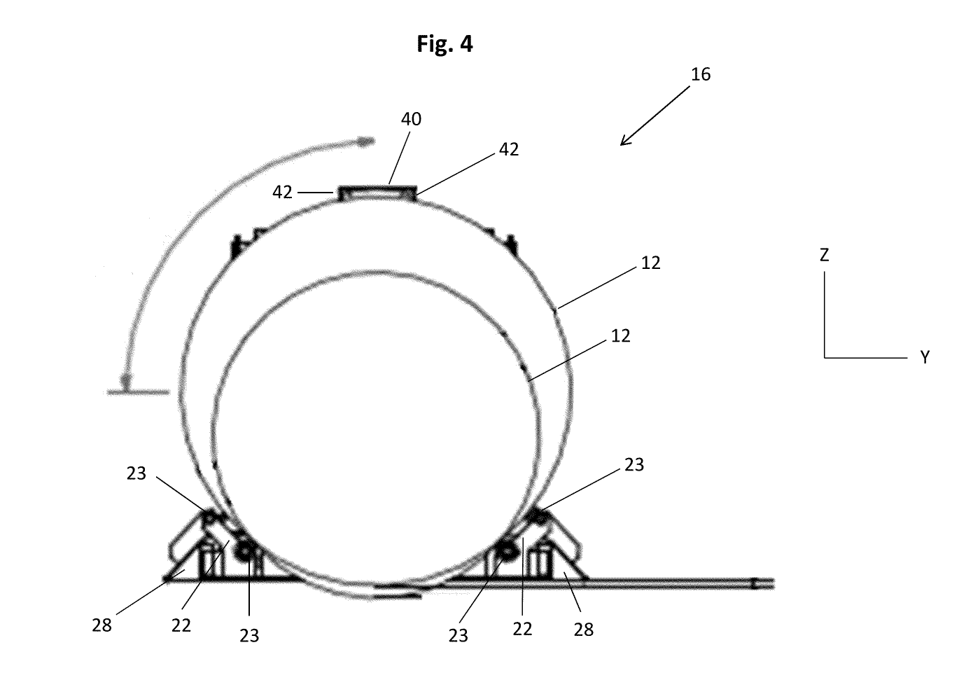

Also shown best in FIG. 3, the contractable structure 20 further includes a clamp 36 adapted to contact a surface of the wheel and 12 secure the wheel 12 with respect to the wheel support devices 22. In the illustrated form the clamp 36 contacts an upper surface of the wheel in use. The clamp 36 comprises an extendible body 38 and a securing projection 40. In use, the extendible body 38 extends in a radial direction of the wheel 12 to support the wheel 12. The extendible body 38 is extendible to fit different size wheels (as shown in FIG. 4).

The wheel support devices 22 and the securing projection 40 are configured to be spaced apart about the circumference of the wheel 12. In the illustrated embodiment, the wheel support devices 22 and the securing projection 40 are evenly spaced apart about the circumference of the wheel.

Also shown in FIG. 3, the handling device 16 defines a space 42 between the connector 14 and the plurality of wheel supports 22 allowing a person to stand in the space 42. In the illustrated form, the space 42 is defined between the handling device and the wheel supports 22. The space 42 enables a person to make any necessary adjustments to wheel fastening mechanisms (not shown) such as bolts or similar when removing or replacing the wheel 12. The space 42 allows greater access to the wheel by a person in a safe manner because the handling device 16 is not able to move any further toward the connector 14 once it is in the proximal position.

Referring to FIG. 4, a front view of the wheel handler 10 is shown. The securing projection 40 of the clamp 36 and the wheel support devices 22 are adapted to rotate the wheel 12 about a central axis to facilitate removal of the wheel 12 from the vehicle using a motorized rotation device (not shown). The rotation enables the user to bring the wheel 12 into alignment to fasten the wheel fastening mechanisms.

Each wheel support 22 comprises two contact members 23. The securing projection 40 of the clamp 36 also comprises two upper contact members 42. Each contact member 23, 42 is in the form of a roller facilitating the rotation of the wheel 12. In some forms rotation of one of the rollers is automated allowing for simple rotation of the wheel without requiring a user to rotate the wheel manually. In some forms a hydraulic system is utilised to rotate the wheel. In some forms the hydraulic system is associated with the clamp or a wheel support.

Embodiments of the wheel handler 10 permit greater control in affixing the wheel 12 to a vehicle because the handling device 16 controls movement of the wheel 12 and supports the weight of the wheel 12. The handling device 16 is capable of smooth incremental movement in at least three independent directions, the X, Y and Z directions as described above. As a result, a second person is not required to operate the wheel handler 10, which minimises the exposure of people in front of machinery in confined spaces with limited visibility.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence of addition of further features in various embodiments of the process and product.

1. A wheel handler for handling a wheel in a confined space, the wheel handler comprising:
a connector for connecting the wheel handler to a drive vehicle; and
a handling device that in use is adapted to support the wheel, wherein at least a portion of the handling device is moveable in a lateral direction relative to the connector such that a wheel supported by the handling device is moved in a lateral direction relative to the connector.

2. The wheel handler according to claim 1, wherein at least a portion of the handling device in use is moveable in a longitudinal direction relative to the connector such a wheel supported by the handling device is moveable between a proximal position and a distal position in relation to the drive vehicle.

3. The wheel handler according to claim 1, wherein at least a portion of the handling device in use is moveable in a vertical plane relative to the connector such that a wheel supported by the handling device is moved in a vertical direction relative to the connector.

4. The wheel handler according to claim 1, the handling device comprising a contractable structure having a plurality of wheel supports configured such that a wheel supported by the wheel supports is moveable to the proximal position upon contraction.

5. The wheel handler according to according to claim 1, the contractable structure further comprising a clamp adapted to contact a surface of the wheel and secure the wheel with respect to the wheel supports.

6. The wheel handler according to claim 5, wherein the clamp comprises an extendible body and a securing projection, and the extendible body extends in use in a radial direction of the wheel to support the wheel.

7. The wheel handler according to claim 4, the plurality of wheel supports and the securing projection are configured to be spaced apart about the circumference of the wheel.

8. The wheel handler according to claim 1, the handling device is in sliding engagement with the connector such that the handling device is moveable laterally in relation to the connector.

9. The wheel handler according to claim 8, wherein the handling device comprises a contractable structure having a plurality of wheel supports configured such that a wheel supported by the wheel supports is moveable to the proximal position upon contraction and the sliding engagement is in a direction that is substantially transverse the direction of movement of the plurality of wheel supports.

10. The wheel handler according to claim 1, the wheel handler further comprising a motorized rotation device adapted to rotate the wheel about a central axis to facilitate removal of the wheel from the vehicle.

11. The wheel handler according to claim 4, wherein the handling device defines a space allowing a user to stand between the connector and the plurality of wheel supports.

12. A method of removing a wheel using the wheel handler defined in claim 1.

13. (canceled)

14. The wheel handler according to claim 8, wherein the contractable structure further comprising a clamp adapted to contact a surface of the wheel and secure the wheel with respect to the wheel supports and the sliding engagement is in a direction that is substantially transverse the direction of movement of the plurality of wheel supports.

15. The wheel handler according to claim 5, wherein the handling device defines a space allowing a user to stand between the connector and the plurality of wheel supports.
